(19) United States
(12) Patent Application Publication
(10) Pub. No.: US 2017/0168634 A1
(43) Pub. Date: Jun. 15, 2017

(54) OPERATING AID FOR A TOUCH-SENSITIVE DISPLAY

(71) Applicant: Lucian Cristian Depold, Sindelfingen (DE)

(72) Inventor: Lucian Cristian Depold, Sindelfingen (DE)

(21) Appl. No.: 15/114,821

(22) PCT Filed: Jan. 28, 2015
(86) PCT No.: PCT/EP2015/000159

§ 371 Date: Oct. 2, 2016

(30) Foreign Application Priority Data
Jan. 30, 2014 (DE) 20 2014 000 752.7

(51) Int. Cl. G06F 3/041; G06F 3/039; G06F 3/045; G06F 3/01; G06F 3/044

(52) U.S. Cl. CPC G06F 3/0416; G06F 3/0412; G06F 3/016; G06F 3/044; G06F 3/045; G06F 3/039; G06F 2203/04105

(57) ABSTRACT

The invention relates to an operating aid (10) for use on a touch-sensitive display (4), having a base element (12) which has an adhesive layer (16) for removably attaching to the display (4), said adhesive layer being provided on a display-side surface (14), and on which at least one activation region (24) is provided. The activation region can be detected in a tactile manner on a user-side outer face (20) facing away from the display-side surface (14), and the activation region can be used to act upon a signal zone (28) which can be positioned on the display-side surface (14) in order to generate a control signal that can be detected on the display (4). A detectable pressure actuation zone (30) is provided on the activation region (24). The pressure activation zone can be brought into a passive position, in which no control signals can be generated on the signal zone. The activation region (24) has an elastic material design (32) on the pressure actuation zone (30) between the display-side surface (14) and the user-side outer face (20). The material design has a first material thickness (M1) which exceeds the signal zone (28) in a passive position and a smaller second material thickness (M2) in an active position, and the pressure actuation zone (30) can be moved from the passive position, in which the pressure actuation zone is arranged at a distance from the signal zone (28), into the active position, in which the control signal is generated, by applying pressure.

### TECHNICAL FIELD

The invention relates to an operating aid for use on a touch-sensitive display of an electronic device, such as a smart phone or tablet computer.

### BACKGROUND

Operating-aids for touch-sensitive displays are generally known. Such operating aids are often used, for example, in games that are played on a tablet computer or a smart phone with a touch-sensitive screen, to give the player tactile actuation regions over which he can actuate the respective virtual control elements of the device. The tactile actuation regions thereby allow the player easier operation and provide an improved gaming experience.

The Invisible Gampad™ of the Obinova LLC company is known for this on the market, for example. This operating aid essentially consists of a thin transparent adhesive film, in which, for example, cross-shaped or circular recesses are embedded. The film is glued over a virtual control element of a game on the display of the electronic device in question. The user can then execute a guided control movement along the edges of the recesses or actuate a virtual control element via the actuation region. A corresponding operating aid is shown, for example, in US 2013 0095301 A1.

A disadvantage of the known operating aid is that in the moment in which the actuation region or the respective material recess is being tactilely sensed, a control signal is usually also delivered to the display surface. In addition, the transparent adhesive film used is so thin that a control signal can be generated next to the material recess through the adhesive film. Further, the known operating aid that is primarily intended for permanent disposition on the respective device has the disadvantage that it can only be removed from the display surface relatively cumbersomely.

Furthermore, operating aids are known by means of which a conventional alphanumeric keyboard can be at least subsequently modeled on a touch screen.

US 2011/0241999 describes a keyboard for this that can be attached, for example, retroactively by means of lateral adhesive regions on a touch screen. The individual keys are thereby formed by a thin plastic profile which is modeled on the outside after a conventional alphanumeric keyboard key and hollow inside. By pressing the respective top side of these keys, this can be shifted so far inward that the finger is sufficiently close to the touch screen in question to trigger a signal.

U.S. Pat. No. 8,206,047 B1 and U.S. Pat. No. 8,790,025 B2 each describe a keyboard in which the individual keys are also formed by a thin plastic profile, which is modeled on the outside of a conventional alphanumeric keyboard. On the inside, the keys in this case each have a support structure, which is also formed by a thin plastic profile and which perceptibly collapses when pressed on the upper side of the keys to simulate the pressure point of a conventional keyboard as faithfully as possible.

Digital games generally require a quick change between the available virtual actions of the player character. A rapid change of the thumbs between the existing knobs results from this when controlling such games with game pads of conventional game consoles (e.g., “XBOX 360” or “Playstation 4”). The thumbs thereby exert pressure on the surface of the game pad in order to find the desired knob and where necessary to also immediately activate them with greater pressure. The exertion of pressure in combination with the movement of the thumb thereby generates a relatively high frictional resistance.

The keys of the keyboards mentioned are configured to be pressed from above for this purpose. A change between keys while exerting pressure, as is demanded by classical game pads would, however, pull the plastic profile of the currently pressed key in the direction of the other key and thus possibly make alternating between the two keys difficult. Such keyboards are also only compatible with certain device models, since they require a certain device width in order to be mounted by means of adhesive regions abutting the side.

Such keyboards are not practical for most gaming applications due to their shape. Moreover, the production costs of such keyboards are relatively high.

### SUMMARY

The object of the invention is to avoid said disadvantages in a generic operating aid and in particular to enable a differentiated triggering of the control signals as well as a more comfortable attachment and detachment in game applications.

An improved operating aid has a base element on which an adhesive layer is provided on a display-side surface for removable attachment on the display. In addition, at least one activation area is provided on the base element that can be detected tactilely on a user-side outer side facing away from the display-side surface.

A signal zone can be acted upon via this activation area, which can be positioned on its display-side surface when attaching the operating aid on the respective display and inside of which, for example, the resistive or capacitive control signal can be generated. The signal zone is thereby generated by the switched-on display and extends, depending on operation of the touch-sensitive display, either only directly on its surface or rather on the display-side surface of the operating aid, such as in the case of a resistive touch screen, or, as in the case of a capacitive touch screen, is formed by an electric field, which extends from the display-side surface to some extent into the operating aid. In particular, the extension of the signal zone can be increased in this case by using a conductive material of the operating aid. A control signal can thereby be generated via the activation zone and the signal zone by touching on the user-side outer side, which can be detected by the display or rather by the electrical equipment and converted into a control command.

A tactile pressure actuation zone is thereby provided on the activation area, which can be brought in a passive position or is positioned permanently therein, wherein a control signal is not generated or cannot be generated via the signal zone in this passive position. Through this, the pressure actuation zone can be tactilely sensed by the user or rather the user can leave a finger on the pressure actuation zone, which is arranged spaced from the signal zone at least in an unloaded state, so that the transmission of the control signal is inhibited in the pressure actuation zone.

The activation area on the pressure actuation zone between the display-side surface and the user-side outer side has an elastic material structure. Through this, the pressure actuation zone can be brought into an active position by applying pressure from the passive position in which the pressure actuation zone is arranged spaced to the signal zone, in which the pressure actuation zone is arranged with the finger adjacent to it, for example, partially within the signal zone, and a control signal can be generated through it. In the passive position, the material structure of the activation area, in this case, has a first material thickness surpassing the spatial extension of the signal zone, which ensures that no control signal can be transmitted.

Through application of pressure to the pressure actuation zone, the elastic material structure can then be brought into the active position in which it has a second material thickness, by which the transmission of the control signal is released. The user can thus keep his fingers ready in the pressure actuation zone of the activation area in gaming applications without a control signal being generated. And only then, when he would like to additionally generate a control signal, he changes his position, for example, in a horizontal or vertical direction toward the signal zone. In this, a change detectable by the electronic device, in particular capacitive or resistive change, is generated or rather an application of pressure to the display surface, which is converted to the desired control signal. In this way, a type of pressure point can be kept on the pressure actuation zone through which a more comfortable and more precise control of the electronic device is possible, in particular with game applications. Here, the transmission of the control signal in the passive position is blocked by the material structure of the activation area, while the transmission of the control signal is released in the active position. Through this vertical adjustability of the material structure, it is possible to tactilely sense the pressure actuation zone in the passive position without a control signal being generated by this. And only then, when he would also like to generate a control signal at this position, the user applies sufficient pressure on the pressure actuation zone in order to displace the pressure actuation zone into the active position. Here, the respective operating finger of the user reaches through the elastic deformation of the material structure in the signal zone, in which he generates a control signal on the display.

Advantageously, in the active position the pressure actuation zone is thereby arranged at least partially and the second material thickness is arranged completely within the spatial extension of the signal zone, whereby the transmission of the control signal is released. In this way, for example, a detectable change in capacitance can be generated as a consequence of arranging a finger adjacent to the display surface. With this approach, a difference of the material thickness of the structure can be predetermined, which must be achieved by elastic deformation before a control signal is generated on the activation area in question. In this way, it can be ensured that an unwanted control signal is not generated with the mere tactile sensation of the activation area or rather with the mere application of the user's finger, but rather until a certain pressure point must be reached for this. In addition, virtual control elements of the display, which should not be actuated for the respective application, can be covered in this way by means of the material structure in order to not be inadvertently actuated. The soft material structure of the pressure actuation zone also forms a type of material ramp in the pressed-in state which allows the finger to be able to easily leave the pressure actuation zone when pressure is exerted.

It is thereby advantageous if the material structure is at least formed by the adhesive layer and an elastic backing layer of the base element and the first material thickness is at least 0.8 mm in the passive position. This can reliably prevent the transmission of a control signal in the passive position of the pressure actuation zone, for example, when using a polymer and/or one or more microfiber layers for the material structure of the activation area. The adhesive layer thereby fixes each individual pressure actuation zone in its current position on the touch screen and largely blocks the elasticity of the soft material in the plane parallel to the touch screen. The elasticity is present as a pressure point almost entirely orthogonal to the touch screen plane. Since each pressure actuation zone is self-adhesive, the operating aid can also consist of several, freely combinable parts and requires no specific device width in order to be attached. Thus, the operating aid is compatible with a variety of devices, through which the manufacturing and development costs decrease.

Advantageously, the adhesive layer is formed by a polymer layer which has a plurality of pores on the display-side surface, by means of which a negative pressure can each be generated on the display surface. The base element can be fastened with particular stability to the display surface in question by such a polymer layer and also be detached from this easily and without residue again after use. Through the plurality of open pores of the polymer layer via which the adhesive effect is generated here, a high number of reuses of the operating aid is possible before the adhesive effect noticeably decreases. Further, such polymer layers also adhere to very dusty or greasy surfaces. In addition, such adhesive layers can be manufactured very soft or very thin, so that they support and do not hinder the pressure point created by the elastic material structure. A corresponding polymer layer is described in more detail, for example, in U.S. Pat. No. 7,431,983 B2.

Furthermore, it is advantageous if the backing layer is formed by a foamed plastic, such as, for example, foam rubber. This allows the operating aid be produced inexpensively and with a suitable pressure point for game applications. Another possibility for the production of a soft backing layer would be the use of a gel which is enclosed by a smooth membrane, similar to gel inserts of bicycle seats or shoe inserts.

Advantageously, the base element is also at least partially formed of anti-static material, whereby the occurrence of unwanted electrostatic charges on the operator aid or the touch-sensitive display is prevented. In this manner, electric charges which could briefly block the function of an operating aid are avoided. Such charges can arise while playing, if the control finger often moves back and forth between multiple regions. During changing, the finger is usually thereby held on the operating aid, wherein friction is generated.

In a particularly advantageous embodiment, the base element is also formed at least transparent over some regions, wherein, for example, the backing layer is formed by a transparent material and the adhesive layer in addition formed so thin that the base element is transparent overall. Through this, parts of the display may be kept visible through the operating aid, which facilitates, for example, the accurate attachment of the operating aid.

Further, it is advantageous if multiple recesses for the adjustment of a desired pressure point on the respective pressure actuation zone are set in the elastic material structure, such as, in particular, continuous openings. Here, the material recesses have, for example, a plurality of small, continuous recesses or rather perforations on the groove bottom, the knob bottom or troughs, which can be, for example, in the form of circles, squares or hexagons. These recesses can be between 0.2 mm and 4 mm wide. Through the number and size of these recesses, the pressure required for signal generation, on the one hand, can be adjusted, wherein less pressure is required through the reduction of the material. On the other hand, the screen on which the operating aid is attached, is made visible by the perforations through it.

Moreover, it is advantageous if the pressure actuation zone is formed by a material recess of the activation area, such as a punch out. This enables a particularly simple and inexpensive production of the operating aid with different shapes and different numbers of tactile pressure actuation zones. The material recess can thereby be designed, for example, circular or elliptical, teardrop-shaped, polygonal or slit-like. In addition, they may both be formed the same by a complete opening of the material recess as well as also only by a tangible edge section.

Advantageously, the material recess is thereby designed as a continuous recess of the base element, such as in the form of a punch out. A relatively free shaping with respect to the activation area is possible in this way.

Furthermore, it is advantageous if the material recess is designed trough-shaped and the display-side surface forms a closed area, whereby the display surface in question may be particularly well protected against mechanical stresses during operation.

In addition, the material recess has a maximum extension, such as a diameter of a circular or elliptical recess, from 3 to 10 mm. The pressure actuation zone can be easily tactilely sensed through this without the finger in question coming into direct contact on the display. Instead, the display is only touched through a pressure-induced deformation of the pressure actuation zone or of the fingertip. The maximum extension is thereby thus selected as a function of the shape of the recess, the thickness of the base element and optionally on the user's finger size so that direct contact of the finger via the recess on the display without contact on the material of the operating aid is not possible.

Advantageously, the material recess forms a first circumferential groove. For example, an easier, more fluid passage of the finger from one direction to another direction is possible through this groove, which, as a result, also has a more fluid movement of the game figure. In particular, free movement without stopping is possible when changing direction.

It is thereby advantageous if a second circumferential groove arranged concentrically to the first circumferential groove is provided, wherein a tactilely detectable separation element is provided between the two grooves. The speed of the game figure in many game applications can thus be better controlled, for example, if a slower motion is generated via one groove than via the other groove.

In a particularly advantageous embodiment, the pressure actuation zone is formed by an actuation contour projecting over a user-side surface of the base element, whereby tactile detection of the pressure actuation zone is particularly easy. In addition, the control signal can be generated in a comfortable way by the actuation contour projecting from the base element.

It is thereby advantageous if the actuating contour is formed by a knob that projects with a tappet section into the material recess of the base element, through which, for example, the control signal can be generated in an especially comfortable way by touching the display surface.

Advantageously, the knob is, in this case, at least partially electrically conductive, whereby a capacitive change detectable on the display surface can be produced by means of the knob.

Moreover, it is advantageous if the material recess is formed continuous and the tappet section can be displaced completely through the base element, whereby the operating aid can be used both for capacitive as well as resistive touch screens.

In an advantageous embodiment, the tappet section can be applied to a bottom of the material recess formed as a trough, whereby the display surface can be particularly well protected against mechanical stresses.

In a further advantageous embodiment, the actuating contour is formed by a blister, which enables a particularly cost-effective manufacture of the actuating contour.

It is advantageous if the blister can be everted by applying pressure in the active position. Through this, the active position of the pressure actuation zone can be particularly clearly distinguished from the passive position, which allows a more accurate control of the electronic device.

In a further advantageous embodiment, the actuating contour is formed by an annular collar made of elastic material, which is placed adjacent to the recess on the base element. A relatively large difference between the thickness of the material structure in the passive position and in the active position can be predetermined through this in order to generate a certain pressure point in a simple manner.

In an advantageous embodiment, the material recess of the activation area is formed by a first circumferential groove, whereby a flat, continuous actuation region can be generated. The pressure point may thereby be generated either by a soft groove above the signal zone and/or (both together is possible!) a small selected groove width (between 2 mm and 10 mm), which makes it impossible to put the finger on the groove bottom without exerting pressure on the groove edges. In addition, it is favorable if the groove has indentations/recesses (for example, in at least four of the eight cardinal directions), whereby tactile recognition of these positions is facilitated. The tactile recognition of the indentations/positions during the application of pressure can also be reinforced by continuous recesses in the groove bottom (for example, in the form of holes or rounded triangles).

In a further advantageous embodiment, the first circumferential groove has at least one further circumferential groove, which is arranged concentrically to the first groove and which is delimited by a tactilely detectable separation element. The separation element prevents accidental transition from one groove to the other groove. In some game applications, the speed of game figures can thus be controlled, since the inner grooves might cause slow movements and the outer fast.

These operating aids are particularly advantageous for the control of game figures in virtual space. An easier, more fluid passage of the finger from the west direction into the northwest direction is, for example, possible through this circumferential groove, which also consequently has a fluid movement of the game figure. Easy movement was actually also possible with the original directional pad, however, the material structure between the west and northwest direction might have created a short stop of the game figure as a result.

In a very advantageous embodiment, at least one edge of a pressure actuation region or a protruding contour is rounded. Leaving an activation area under application of pressure is thus simplified, since the rounded edge forms a type of ramp, which generates less resistance than an edge. Particularly with grooves, a rounded edge also allows a comfortable (painless) following of the groove while applying pressure.

### BRIEF DESCRIPTION OF THE DRAWINGS

An exemplary embodiment of the invention is shown in the figures.

FIG. 1 is a perspective view of an electronic device with two operating aids according to the invention attached to a display.

FIG. 2 shows the electronic device according to FIG. 1 with detached operating aids.

FIG. 3 is an enlarged view of the operating aids according to FIG. 2.

FIG. 4a is a sectional side view of the attached operating aid according to FIG. 3 in a passive position.

FIG. 4b is a sectional side view of the operating aid according to FIG. 4a in an active position.

FIG. 4c is a sectional side view of an alternative embodiment of the operating aid according to FIG. 4a in the active position.

FIG. 5a is a perspective view of another embodiment of the operating aid according to the invention with a trough-shaped material recess.

FIG. 5b is a sectional side view of the operating aid according to FIG. 5a in the passive position.

FIG. 5c is a sectional side view of the operating aid according to FIG. 5a in the active position.

FIG. 6a is a perspective view of another embodiment of the operating aid according to the invention with an actuating contour formed by a knob.

FIG. 6b is a sectional side view of the operating aid according to FIG. 6a in the passive position.

FIG. 6c is a sectional side view of the operating aid according to FIG. 6a in the active position.

FIG. 7a is a perspective view of another embodiment of the operating aid according to the invention with an actuating contour formed by a blister.

FIG. 7b is a sectional perspective view of the operating aid according to FIG. 7a.

FIG. 7c is a sectional side view of the operating aid according to FIG. 7a in the passive position.

FIG. 7d is a sectional side view of the operating aid according to FIG. 7a in the active position.

FIG. 8 is a perspective view of another embodiment of the operating aid according to the invention with an actuating contour formed by an annular collar,

FIG. 9 is a perspective view of another embodiment of the operating aid according to the invention with an activation area formed by a circumferential groove.

FIG. 10 is a perspective view of another embodiment of the operating aid according to the invention with a circumferential groove, which has a plurality of indentations.

FIG. 11 is a perspective view of another embodiment of the operating aid according to the invention with two concentrically arranged grooves.

FIG. 12 is a perspective view of another embodiment of the operating aid according to the invention with a groove, whose edges have a raised contour.

FIG. 13 is a partially sectioned view of an alternative embodiment of a material recess of the operating aid according to the invention, which has a rounded edge.

### DETAILED DESCRIPTION

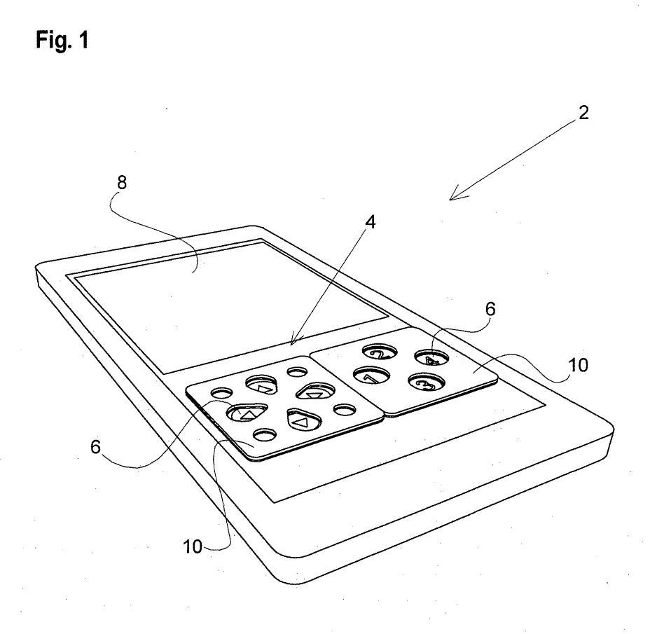

FIG. 1 shows an electronic device 2 in the form of a smart phone with a touch-sensitive display 4 such as a capacitive or resistive touch screen. The touch-sensitive display 4 displays multiple virtual control fields 6, which are represented as arrows or numbers. The control fields 6 are used for inputting control signals by a user, by means of which, for example, virtual game figures (not shown) can be moved within an also displayed playing area 8.

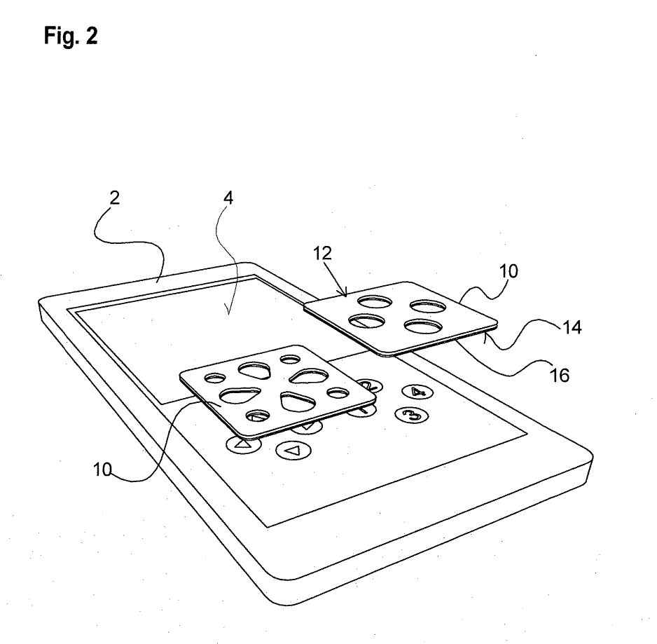

To thereby enable a more comfortable and more precise actuation of the control elements 6, two operating aids 10 were subsequently attached to the display 4, which can be detached from the display after use, as shown in FIG. 2.

The operating aids 10 have a flat base element 12 for this purpose whose display-side surface 14 is formed by an adhesive layer 16 in the form of an elastic polymer layer. The polymer layer in this case is, for example, permeated by microscopic air bubbles that form a plurality of open pores on the display-side surface 14 (not shown). When pressing this adhesive layer 16 against the display 4, a negative pressure is respectively generated by elastic restoring forces in the pores by which the base element 12 can be held on the display 4.

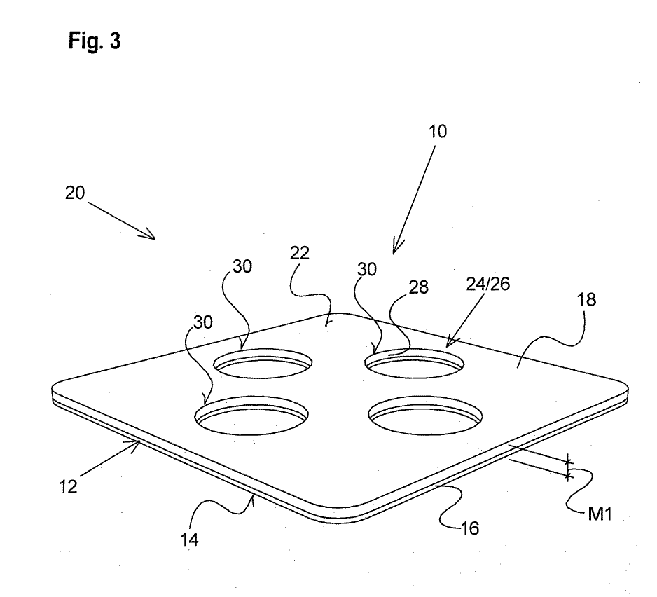

In particular, FIG. 3 shows that the elastic polymer layer 16 is held on a backing layer 18, which forms a user-side surface 22 of the base element 12 on a user-side outer side 20 of the operating aid 10 facing away from the display-side surface 14 and which is, for example, formed from an elastic material, such as a polymer layer, or from a microfiber layer. Alternatively, for this purpose, the backing layer 18 may also be formed by a foamed plastic, such as foam rubber.

In addition, the base element 12 can be designed anti-static as a whole or at least partially contain anti-static material. In addition, the base element 12 may be formed at least transparent over a region, wherein, for example, the backing layer 18 is formed by transparent material and the adhesive layer 12 is formed so thin that it is even at least partially transparent.

In order to be able to actuate the control elements 6 of the operating aids 10 in the attached state, several activation areas 24 are provided on the base element 12. In the embodiment according to FIG. 3, the activation areas 24 have material recesses 26 in the form of round punch outs. The edges of these material recesses 26 in turn form pressure actuation zones 30 which can be easily felt by the user.

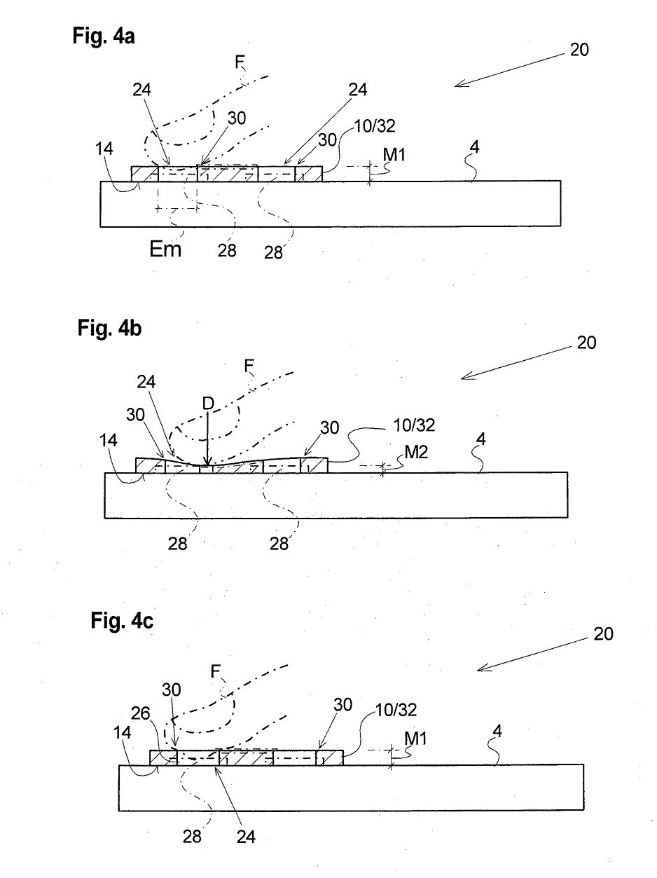

As can be seen in particular from FIG. 4a, the touch-sensitive display 4 generates respectively a signal zone 28 of the activation areas 24 on the display-side surface 14 in the attached state of the operating aid 10. A control signal is generated in these signal zones 28 as soon as a detectable capacitive or resistive change is caused within these, in particular by the entry of a finger F of the user.

The tactile pressure actuation zones 30 provided on the user-side outer side 20 of the operating aid 10, which is formed by the edge of the respective material recess 26, are shown in FIG. 4a in a passive position, in which they are each arranged spaced to the signal zone 28. The material recesses 26 in this case preferably have a maximum diameter or rather maximum extension Em, which is between 4 and 8 mm. Through this, the finger F of the user can tactilely sense the activation area 24 and in particular the pressure actuation zone 30 and can be put on these, without him being able to inadvertently put it over the material recesses 26 on the display and thereby generate an unintended control signal.

Here, the base element 12 has an elastic material structure 32 at least in the activation areas 24 between the display-side surface 14 and the user-side surface 22 or rather the user-side outer side 20. This material structure 32 forms a first material thickness M1 in the shown passive position of the pressure actuation zone 30, which exceeds the vertical extension of the signal zone 28. Through this, the generation of a control signal by the adjacent finger F is effectively prevented by means of the material structure 32.

If a control signal is to be generated now by means of the finger F already adjacent to the activation area 24, a pressure D is applied to the pressure actuation zone 30, as shown in FIG. 4b. The elastic material structure 32 is at least pressed together against an edge section of the pressure actuation zone 30 by this pressure D of the finger F, wherein this shifts in the direction of an active position. In this illustrated active position, the material structure 32 has a significantly lower second material thickness M2, which lies entirely within the vertical extension of the signal zone 28. Through this, the pressure actuation zone 30 lies at least partially inside of the signal zone 28 with the finger F adjacent to it. Consequently, in turn, for example, a capacitive or resistive change to the display-side surface 14 is caused, which is detectable on the part of the display 4 so that a control signal is output to the electronic device 2.

The elastic properties of the material structure 32 can thereby be produced both solely by the adhesive layer 16 or the backing layer 18 or rather preferably through the entire layer structure.

In an alternative embodiment, the operating aid 10, according to FIG. 4c, in which the material structure 32 is substantially rigid, the control signal is generated on the other hand so that the finger F adjacent to the pressure actuation zone 30 is so deformed by exerting pressure on his finger tip, that this projects so far into the material recess 26 that it extends into the signal zone 28, and through it causes a detectable capacitive or resistive change on the part of the display 4.

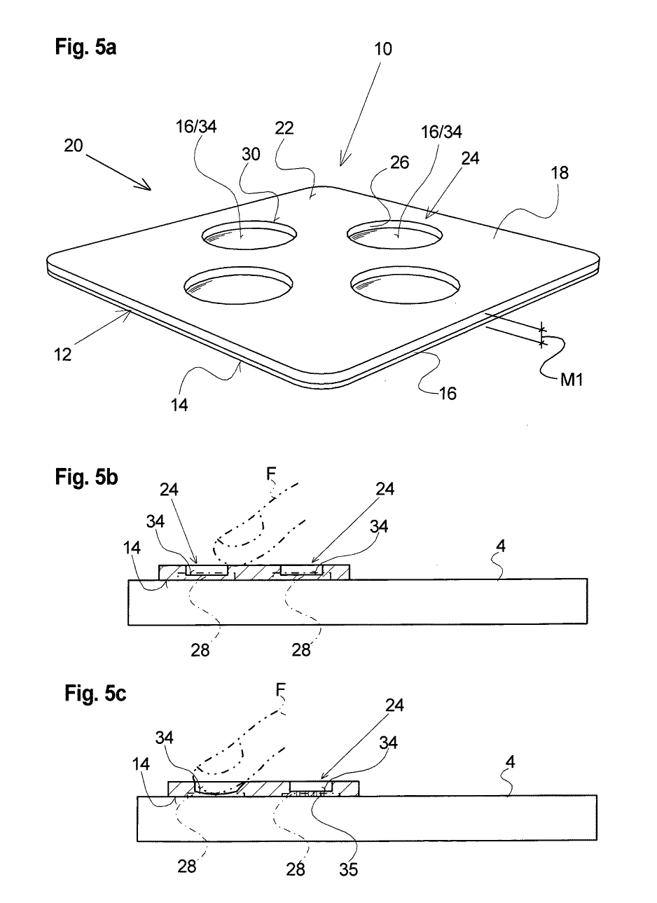

FIG. 5a shows a further alternative embodiment of the operating aid 10 in which the adhesive layer 16 forms a closed surface and the material recesses 26 are designed trough-shaped, for example, by forming a bottom 34 formed by the adhesive layer 16.

In order to also be able to cause a control signal by capacitive change on this operating aid 10, the signal zone 28 extends either from the display-side surface 14 to above the bottom 34 as shown in FIG. 5b, or the bottom 34 is embodied elastically such that the finger F extends into the signal zone upon application of pressure to the bottom 34, as shown in FIG. 5c. In this case, adjustment recesses 35 can be embedded in the bottom 34, which are, for example, 0.2 to 0.4 mm wide and through which the pressure force required for signal generation can be adjusted.

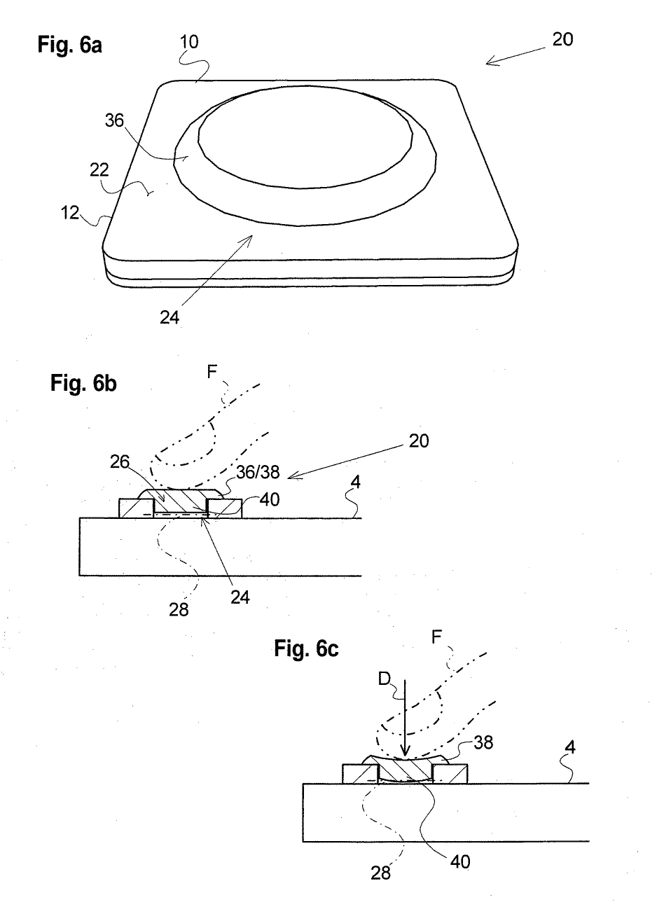

In the following FIGS. 6 to 8, further embodiments of the operating aids 10 according to the invention are shown, which also has a respective activation area 24 with a signal zone 28 and a pressure actuation zone 30 in the attached state on the display 4 according to the operation described above, which can be brought from a passive position into an active position by applying pressure, in which a control signal can be generated by means of the adjacent finger F.

In the embodiment of FIG. 6a, the pressure actuation zone 30 of the activation area 24 of the operating aid 10 is formed by an actuating contour 36, which projects out on the user-side outer side 20 of the operating aid 10 over the user-side surface 22 of the base element 12.

As can be seen in particular from FIG. 6b, the actuating contour 36 is formed in this case by a knob 38 which projects with a tappet section 40 into the material recess 26 of the activation area 24. The tappet section 40 is dimensioned so that it is held spaced to the display 4 or rather the signal zone 28 in the illustrated passive position. In addition, the knob 38 is formed of an electrically conductive material, such as, for example, from an electrically conductive plastic or rather from a plastic into which electrically conductive material is embedded. Through this, the entire knob 38 functions as a pressure actuation zone 30, which can be tactilely sensed in the passive position by the user and on which a finger F can be put without generating a control signal on the display.

In order to generate a control signal on the display 4, a pressing force D of the finger F is applied to the knob 38, whereby this is brought from the passive position into the active position, in which the tappet section 40 reaches into the signal zone 28, as shown in FIG. 6c. Due to the conductivity of the knob 38 in this case, a capacitive or resistive change detectable by the display is generated, which can be converted into a control signal.

Alternatively to the embodiment shown here of the activation area 24 with continuous material recess 26, the display-side surface 14 may also be formed closed (not shown).

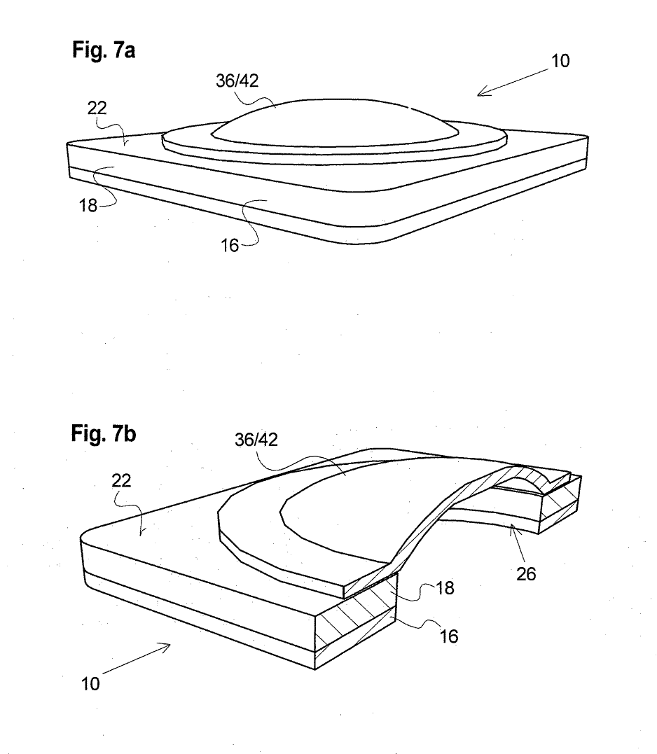

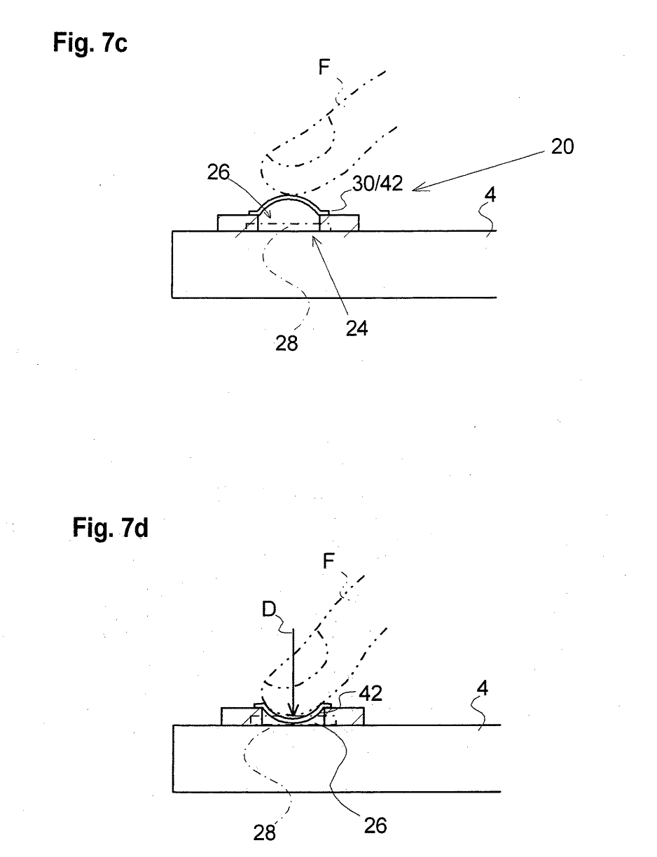

FIGS. 7a and 7b show a further embodiment of an operating aid 10 according to the invention, in which the actuating contour 36 projecting out from the user-side surface 22 is formed by a blister 42 which is affixed, for example, at the edge of the material recess 26 on the backing layer 18. Here, the entire blister 42 functions as a pressure actuation zone 30, which can be tactilely sensed in the passive position by the user and on which the finger F, as shown in FIG. 7c, can be put, without generating a control signal on the display 4.

In order to generate a control signal, pressure D of the finger F is applied to the blister 42, which causes it to evert into the material recess 26 and is thereby brought from the passive position into the active position in which the blister with the finger F adjacent to it reaches into the signal zone 28 as shown in FIG. 7d. In turn, this generates a capacitive or resistive change detectable from the display 4, which can be converted into a control signal.

A closed adhesive layer 16 can also be provided (not shown) here alternatively to the illustrated embodiment of the activation area 24 with continuous material recess 26 on the display-side surface 14.

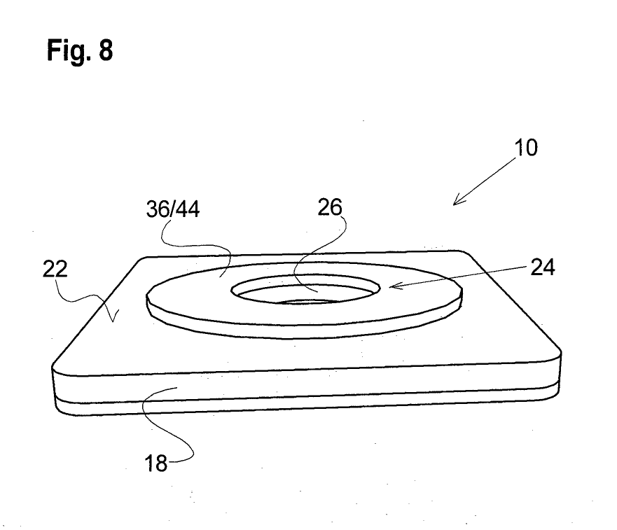

FIG. 8 shows another embodiment of an operating aid 10 according to the invention, in which the actuating contour 36 projecting out from the user-side surface 22 is formed by an annular collar 44 which is affixed, for example, at the edge of the material recess 26 on the backing layer 18. The operation of the operating aid 10 thereby corresponds to the embodiment according to FIG. 4a. The additionally attached collar 44 merely provides that the pressure actuation zone 30 of the activation range 24 can be more easily tactilely sensed. In addition, the distance between the actuating pressure zone 30 and the signal zone 28 can be set almost arbitrarily by the collar 44.

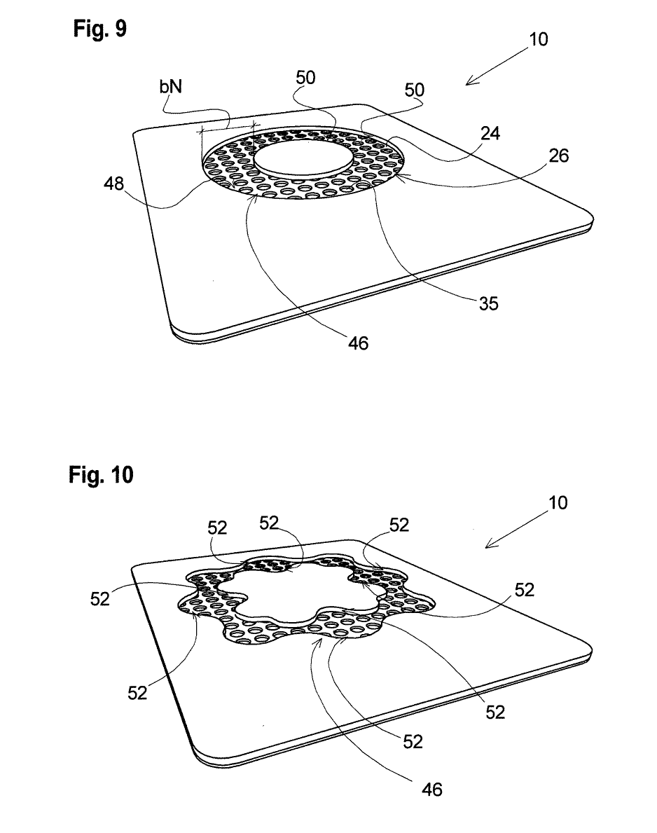

FIG. 9 shows an embodiment of the operating aid 10, in which the material recess 26 of the activation area 24 is formed by a first circumferential groove 46, whereby a flat, continuous activation area 24 can be generated. The pressure point can thereby be generated, for example, by a soft groove bottom 48 reaching over the signal zone 28, which is either smooth or, as exemplified, has a plurality of adjustment recesses 35 for setting the pressure force required for signal generation.

Alternatively or additionally, the pressure point may also be generated by the groove edges 50. For this purpose, the groove has a relatively small groove width bN, such as between 2 mm to 10 mm, whereby putting the finger on the groove bottom 48 is only possible when pressure is exerted on the groove edges 50.

In the embodiment according to FIG. 10, the groove 46 also has several indentations 52 which are directed, for example, in at least four or eight directions, whereby a tactile identification of these positions is facilitated. The tactile detection of the indentations 52 during the application of pressure can also be strengthened by continuous recesses in the groove bottom (not shown).

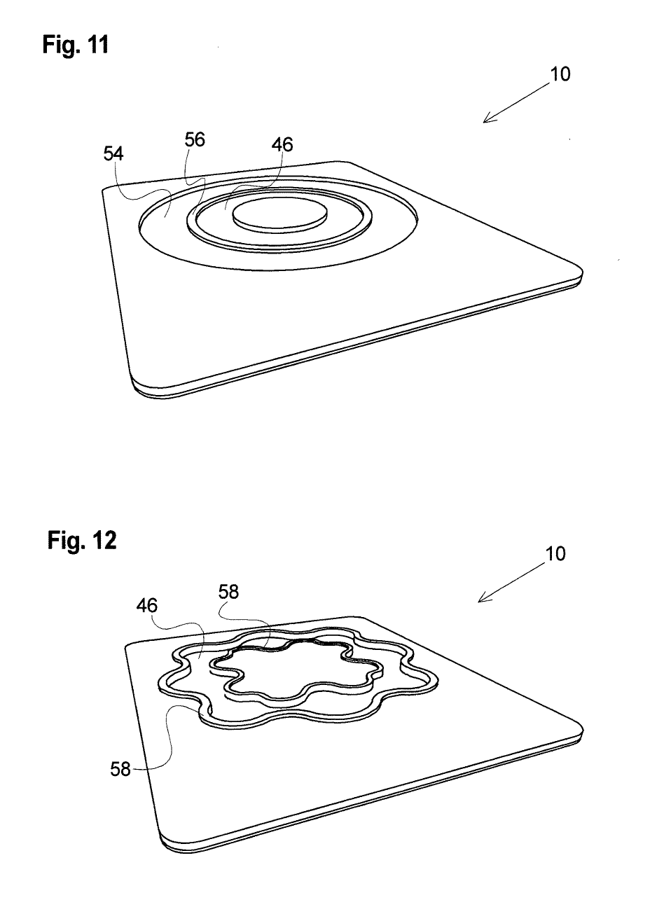

In a further advantageous embodiment, at least one additional circumferential groove 54 is provided in addition to the first circumferential groove 46, as shown in FIG. 11, which is arranged concentrically to the first groove 46. Both grooves 46, 54 are thereby separated from one another by a tactilely detectable separation element 56. The separation element 56 thereby prevents the unwanted transition from a groove 46, 54 to the other groove 54, 46. The speed of the game figures can thus be better controlled in many game applications if, for example, a slower movement is generated via the inner groove 46 than via the outer groove 54.

The operating aids 10 of FIGS. 9 to 11 are particularly advantageous for the control of game figures in virtual space. An easier, more fluid transition of the finger from one direction into another direction is, for example, possible through the respective circumferential groove 46, 54, which consequently also results in a more fluid movement of the game figure. In particular, free movement without stopping is possible when changing direction.

FIG. 12 shows another embodiment of an operating aid 10 with a groove 46, which has a circumferential raised contour 58 on each of its edges, which may be formed, for example, from hard or soft material and provides an improved guide along the groove 46. Such a raised contour 58 can of course also be formed on a plurality of grooves 46, 54 or any other material recess 26 (not shown).

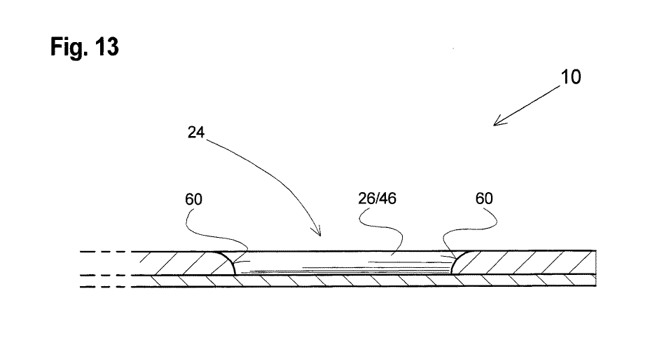

FIG. 13 shows an advantageous embodiment of a material recess 26 of the activation area 24, which is exemplified as a groove 46. This has a rounded recess edge 60. The rounding thereby enables easier removal of a fingertip from the activation area 24 in question also under the exertion of pressure. The rounded recess edge 60 thereby forms a type of ramp, which generates less resistance than a straight edge. Such a rounded recess edge 60 can thereby be applied on any other material recess 26 or on the raised contour 58. Particularly with the grooves 46, 54, the rounded recess edge 60 thereby enables a more comfortable following, exiting or pressing upon the grooves 46, 54 or other material recesses also under the exertion of pressure.

1-22. (canceled)

23. An operating aid for use on a touch-sensitive display, comprising:
a base element, the base element having a display-side surface facing the touch-sensitive display and a user-side surface opposite the display-side surface;
an adhesive layer provided on the display-side surface for removably attaching the base element to the touch-sensitive display;
a tactilely sensible activation area provided in the base element;
a pressure actuation zone extending inwardly from the user-side surface of the activation area; and
a signal zone extending outwardly from the display-side surface of the activation area,
wherein the activation area has an elastic material structure at the pressure actuation zone between the display-side surface and the user-side surface with a first material thickness (M1) when in a passive position and a lesser second material thickness (M2) when in an active position, and
wherein the touch-sensitive display is not caused to generate a control signal when the activation area is in the passive position in which the pressure actuation zone is spaced apart from signal zone, and
wherein the touch-sensitive display is caused to generate a control signal when the activation area is in the active position in which the pressure actuation zone is pushed towards the signal zone.

24. The operating aid as in claim 23, wherein in the active position the pressure actuation zone is arranged at least partially within the signal zone and the second material thickness (M2) is less than a height of the signal zone.

25. The operating aid as in claim 23, wherein the base element comprises an elastic backing layer and wherein the elastic material structure comprises the adhesive layer and the elastic backing layer and wherein the first material thickness (M1) is at least 0.8 mm.

26. The operating aid as in claim 25, wherein the backing layer consists of a foamed plastic.

27. The operating aid as in claim 23, wherein the adhesive layer is a polymer layer which has a plurality of open pores on the display-side surface, and wherein a negative pressure can be generated on the display-side surface.

28. The operating aid as in claim 23, wherein the base element is at least partially made of anti-static material.

29. The operating aid as in claim 23, wherein the base element is at least partially transparent.

30. The operating aid as in claim 23, wherein a plurality of adjustment recesses are embedded in the elastic material structure.

31. The operating aid as in claim 23, wherein the activation area has a material recess.

32. The operating aid as in claim 31, wherein the material recess is a continuous recess of the base element.

33. The operating aid as in claim 31, wherein the material recess is trough-shaped and the display-side surface forms a closed surface.

34. The operating aid as in claim 31, wherein the material recess has a maximum extension between 3 to 10 mm.

35. The operating aid as in claim 31, wherein the material recess forms a first circumferential groove.

36. The operating aid as in claim 35, further comprising a second circumferential groove arranged concentrically to the first circumferential groove and a tactilely sensible separation element between the first groove and the second groove.

37. The operating aid as in claim 23, wherein the activation area comprises an actuating contour which projects outwardly from the user-side surface of the base element.

38. The operating aid as in claim 37, wherein the actuating contour is formed by a knob having a tappet section which projects into a material recess of the base element.

39. The operating aid as in claim 38, wherein the knob is at least partially electrically conductive.

40. The operating aid as in claim 38, wherein the material recess is designed continuous and the tappet section can be completely displaced through the base element.

41. The operating aid as in claim 38, wherein the tappet section is arranged at a bottom of the material recess and wherein the material recess is trough-shaped.

42. The operating aid as in claim 38, wherein the actuating contour is formed as a blister.

43. The operating aid as in claim 42, wherein the blister can be everted by pushing it from the passive position into the active position.

44. The operating aid as in claim 37, wherein the actuating contour has an annular collar of elastic material.
